(19) United States
(12) Patent Application Publication
(10) Pub. No.: US 2004/0065065 A1
(43) Pub. Date: Apr. 8, 2004

(54) Inner nose air filter

(76) Inventor: Michelle Irene Van Patten, Rancho Palos Verdes, CA (US)

Correspondence Address: Michelle Van Patten, 1884 Jaybrook Dr., Rancho Palos Verdes, CA, 90275, US

(21) Appl. No.: 10/266,234

(22) Filed: Oct. 3, 2002

(51) Int. Cl. B01D 46/00

(52) U.S. Cl. 55/385.1

(57) ABSTRACT

I, Michelle Van Patten have invented a new design/utility for an INNER NOSE AIR FILTER as set forth in the following abstract. The inner nose air filter purpose is to reduce the inhaling of air pollution. The invention was born out of the need to alleviate the amount of black residue being expelled from the nose after a day of working in the Los Angeles/Long Beach port environment. The invention is meant to provide a comfortable, functional and readily usable inner nose air filter. It should be disposable and may be provided in basic white as well as various color combinations to promote daily use for the duration of the work shift when subject to the environmental elements of air pollution. The views reveal two cone-shaped cylindrical air filters connected by a nose clip/wire for attachment to the nostril separator or individual insertion. The hope is to reduce nontoxic and possibly toxic substance ingestion.

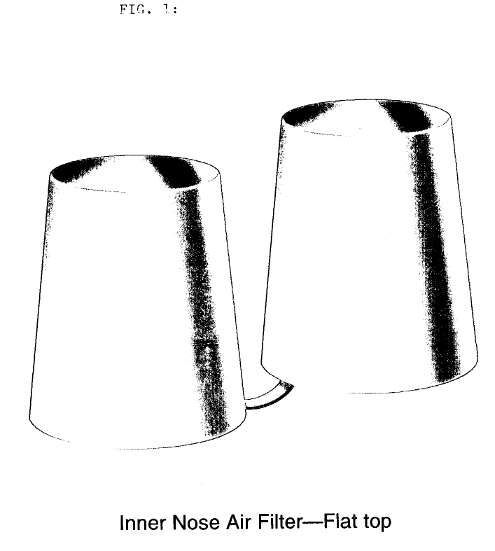

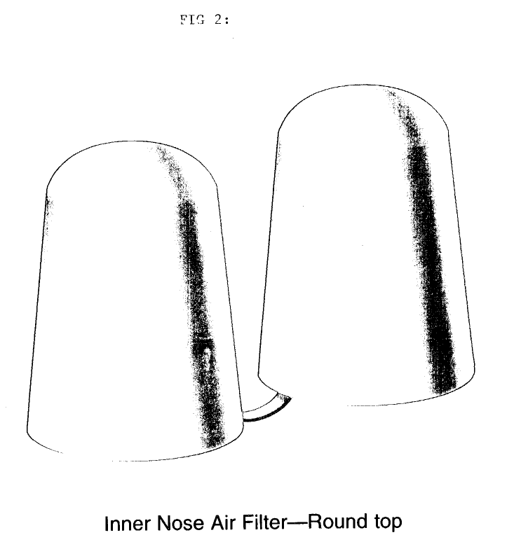

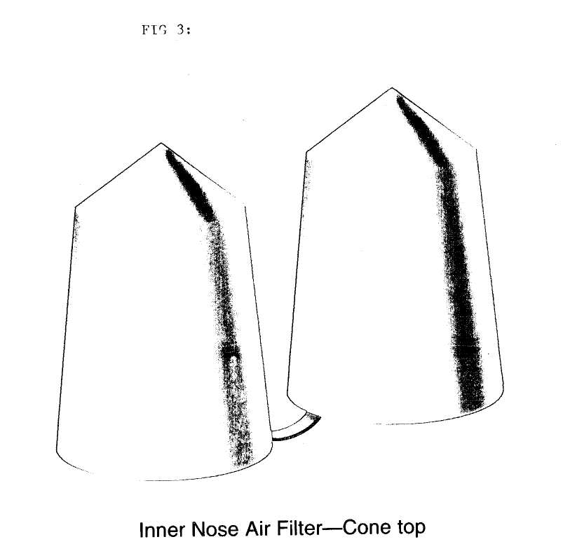

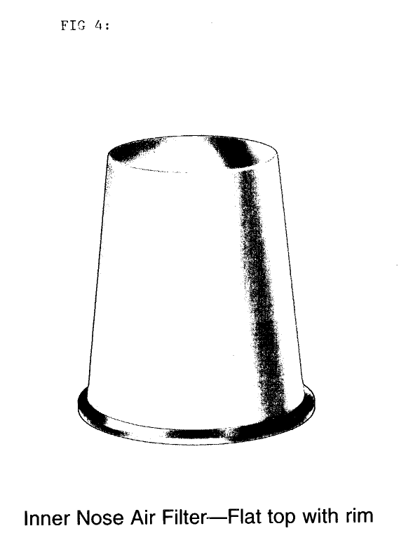

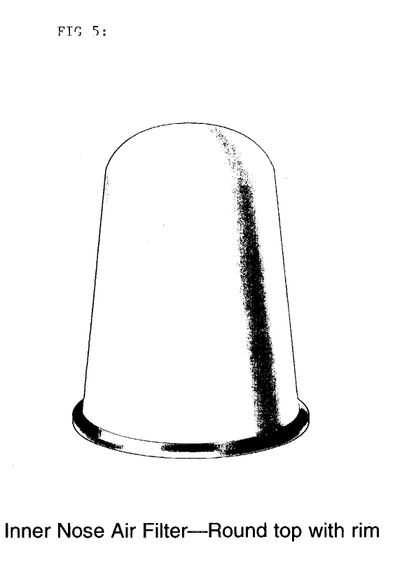

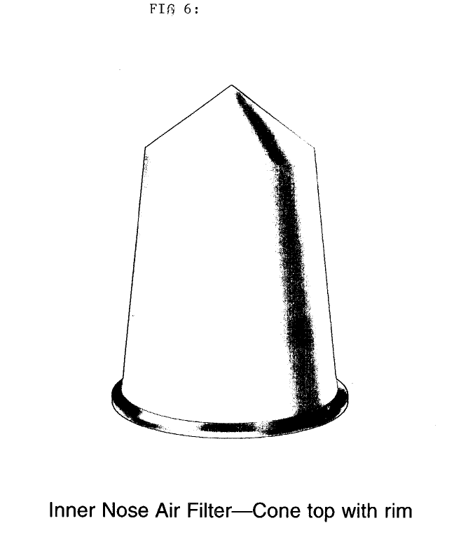

I, Michelle Van Patten have invented a new design/utility for an INNER NOSE AIR FILTER as set forth in the following specifications. This item would be constructed in the basic shape of a cone or cylinder with a ¼+ inch diameter opening and l/4+inch heighth depth. The tip or closed end could have various shapes, for example flat or round or pointed. The open end could have various shapes, for example smooth or lipped. The filters may be constructed individually or as a pair with some type of attachment, for example a clip or a wire. The material is still subject to research, for example NIOSH

APPROVED—N95 particulate respirator material.

1. Michelle Van Patten have invented a new design/utility for an INNER NOSE AIR FILTER as set forth in the following claim. What I claim as my invention is the white/colored design/utility for an inner nose air filter as described in the above referenced US App. No.
